(19) United States
(12) Patent Application Publication
(10) Pub. No.: US 2021/0117974 A1
(43) Pub. Date: Apr. 22, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Eiji NISHI, Kanagawa (JP)

(73) Assignee: FUJI XEROX CO., LTD., Tokyo (JP)

(21) Appl. No.: 16/892,368

(22) Filed: Jun. 4, 2020

(30) Foreign Application Priority Data
Oct. 21, 2019 (JP) 2019-192317

(51) Int. Cl. G06Q 20/40; G06Q 20/14; G06Q 20/08; G06Q 20/32; G06Q 20/30

(52) U.S. Cl. CPC G06Q 20/407; G06Q 20/145; G16Y 10/75; G06Q 20/3224; G06Q 20/308; G06Q 20/085

(57) ABSTRACT

An information processing apparatus includes a money receiving device that is used for receiving money for the information processing apparatus from a user, an accepting unit configured to accept registration of a device other than the information processing apparatus, the device being a target of charging, and a setting unit configured to perform setting such that money for the registered device can be received through the money receiving device.

### CROSS-REFERENCE TO RELATED APPLICATIONS

This application is based on and claims priority under 35 USC 119 from Japanese Patent Application No. 2019-192317 filed Oct. 21, 2019.

### BACKGROUND

### 1. Technical Field

The present disclosure relates to an information processing apparatus and a non-transitory computer readable medium.

### 2. Related Art

For example, JP-A-2017-225137 discloses a charging method for receiving a charging policy for a service domain with a service domain charging management function at a infrastructure node, distributes the policy from the service domain charging management function at the infrastructure node to the service domain charging management function at a destination node, and transmitting a charging report from the service domain charging management function at the destination node to the service domain charging management function at the infrastructure node, in a service layer of a machine-to-machine network.

### SUMMARY

In recent years, a technique called Internet of Things (IoT), for example, has attracted attention, and many products have appeared. However, such a product often does not have a function of implementing charging for convenience of resources.

Aspects of non-limiting embodiments of the present disclosure relate to enabling a device that does not have a function of implementing charging to receive money from a user using a money receiving device that is used for receiving money.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a money receiving device that is used for receiving money for the information processing apparatus from a user; an accepting unit configured to accept registration of a device other than the information processing apparatus, the device being a target of charging; and a setting unit configured to perform setting such that money for the registered device can be received through the money receiving device.

### BRIEF DESCRIPTION OF THE DRAWINGS

Exemplary embodiment(s) of the present disclosure will be described in detail based on the following figures, wherein:

FIG. 1 is a diagram illustrating an example of an overall configuration of an information processing system according to an exemplary embodiment;

FIG. 2 is a diagram illustrating an example of an external appearance of an image processing apparatus according to the present exemplary embodiment;

FIG. 3 is a diagram illustrating an example of a hardware configuration of a control device provided in the image processing apparatus;

FIG. 4 is a block diagram illustrating an example of a functional configuration of the control device provided in the image processing apparatus;

FIG. 5 is a diagram illustrating an example of a charging table;

FIG. 6 is a flowchart illustrating an example of a procedure of processing of registering an electric device that is a target of charging;

FIG. 7 is a flowchart illustrating an example of a procedure of processing of receiving money from a user and operating an electric device;

FIGS. 8A to 8C are diagrams illustrating a specific example of processing of registering an electric device that is a target of charging;

FIGS. 9A to 9D are diagrams illustrating a specific example of processing of receiving money from the user to operate the electric device;

FIG. 10 is a diagram illustrating another example of processing of receiving money from a user and operating an electric device;

FIGS. 11A and 11B are diagrams illustrating another example of processing of receiving money from a user and operating an electric device;

FIGS. 12A and 12B are diagrams illustrating an example of a case where information on money to be charged is output according to a type of electric device; and

FIG. 13 is a diagram illustrating an example of a hardware configuration of a computer to which the present exemplary embodiment is applied.

### DETAILED DESCRIPTION

Hereinafter, an exemplary embodiment of the present disclosure will be described in detail with reference to the accompanying drawings.

### <Overall Configuration of Information Processing System>

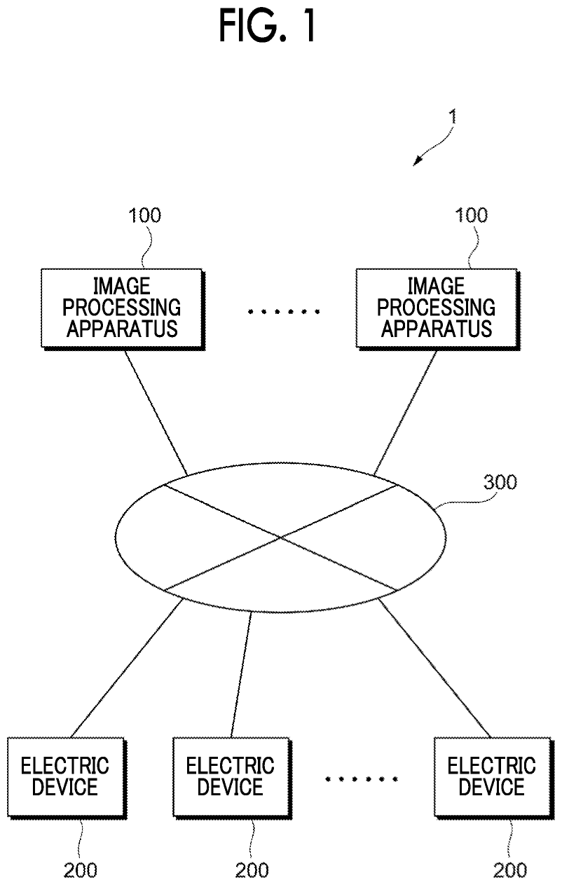

FIG. 1 is a diagram illustrating an example of an overall configuration of an information processing system 1 according to the present exemplary embodiment. As illustrated, the information processing system 1 according to the present exemplary embodiment includes an image processing apparatus 100 and an electric device 200.

Although plural image processing apparatuses 100 are illustrated in the example illustrated in FIG. 1, the number of image processing apparatuses 100 is not limited. Similarly, in the example illustrated in FIG. 1, plural electric devices 200 are illustrated, but the number of electric devices 200 is not limited.

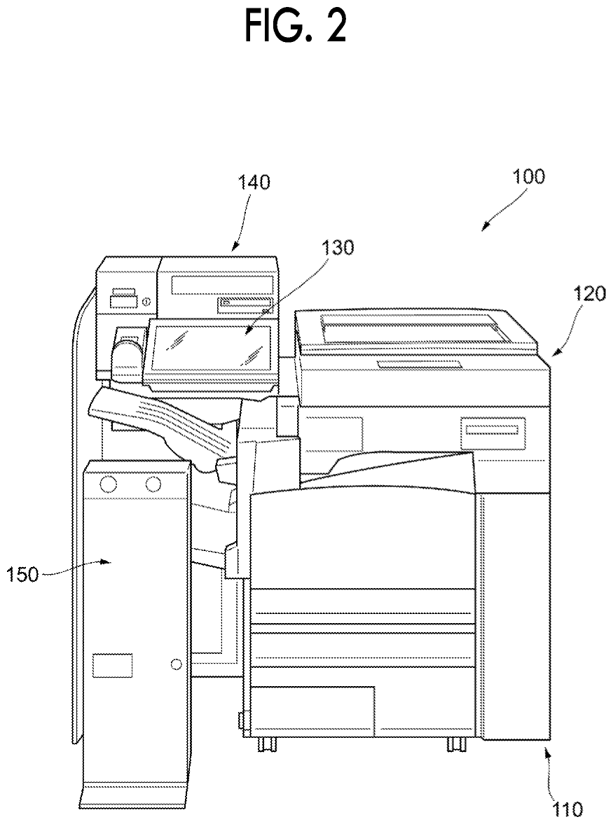

The image processing apparatus 100 as an example of information processing apparatuses has, for example, functions of image processing such as a print function, a scanning function, a copy function, and a facsimile function, and are apparatuses that perform these types of image processing. For example, the image processing apparatus 100 forms an image on a recording material such as a sheet based on image data by a print function. As will be described in detail later, the image processing apparatus 100 includes a money receiving device 150 (which will be described later with reference to FIG. 2) used for receiving money for the image processing apparatus 100 from a user.

The electric device 200 is an electric device having various functions, and for example, an IoT device corresponding to Internet of “Things” (that is, IoT) is exemplified. Specifically, the electric device 200 is, for example, a home appliance such as an air conditioner, a fan, a lighting fixture, and a refrigerator, or various sensors such as a human sensor, an illuminance sensor, or the like.

Here, the electric device 200 does not have a function of implementing charging, and when charging is performed for the processing executed by the electric device 200, the charging processing is performed by the image processing apparatus 100.

In addition, in the present exemplary embodiment, the electric device 200 is in a master-slave relationship with the image processing apparatus 100. When the user operates the image processing apparatus 100, an instruction is issued from the master image processing apparatus 100 to the slave electric device 200, and the electric device 200 executes the processing. When the image processing apparatus 100 issues an instruction to the electric device 200, the electric device 200 establishes a connection with the image processing apparatus 100. Then, the electric device 200 executes processing in accordance with an instruction from the image processing apparatus 100. The money charged for the processing of this electric device 200 is received through the money receiving device 150 (which will be described later with reference to FIG. 2).

While establishing a connection with the image processing apparatus 100, the electric device 200 may establish a connection with an apparatus other than the image processing apparatus 100, but may not establish a connection with an apparatus other than the image processing apparatus 100. In a configuration in which a connection is not established with an apparatus other than the image processing apparatus 100, compared with a configuration in which a connection is established with an apparatus other than the image processing apparatus 100, more resources can be spent on the exchange with the image processing apparatus 100 and the processing executed in accordance with the instructions from the image processing apparatus 100.

A network 300 is a communication unit used for communication of information between devices, and the network 300 is, for example, the Internet, a public line, or a local area network (LAN). The network 300 includes a wired network and a wireless network. In communication using wireless networks, for example, wireless communication standards such as Wireless Fidelity (Wi-Fi (registered trademark)), Bluetooth (registered trademark), and Zigbee are used.

### <Appearance of Image Processing Apparatus>

FIG. 2 is a diagram illustrating an example of an external appearance of the image processing apparatus 100 according to the present exemplary embodiment.

The image processing apparatus 100 includes an image forming apparatus 110 that forms an image on a recording material such as a sheet, an image reading device 120 that reads an image formed on an original document, an operation accepting device 130 that accepts an operation from the user and displays various information to the user, and a data reading device 140 that reads data from a portable storage medium including an SD card, a Universal Serial Bus (USB) memory, a compact disc (CD), and the like, and writes data to the portable storage medium.

The image processing apparatus 100 further includes the money receiving device 150 having a function of accepting money put by the user and returning money as necessary.

Here, the money received by the money receiving device 150 is, for example, a coin or a bill, or both a coin and a bill. Also, money is not limited to cash, but broadly includes payment instruments that are alternatives to cash. Specifically, for example, electronic money by an integrated circuit (IC) card or a prepaid card is exemplified.

The image processing apparatus 100 further includes a communication device 160 for communicating with the outside, and a control device 170 for controlling the image processing apparatus 100. However, in the example illustrated in FIG. 2, the communication device 160 and the control device 170 are built in the image processing apparatus 100.

### <Hardware Configuration of Control Device>

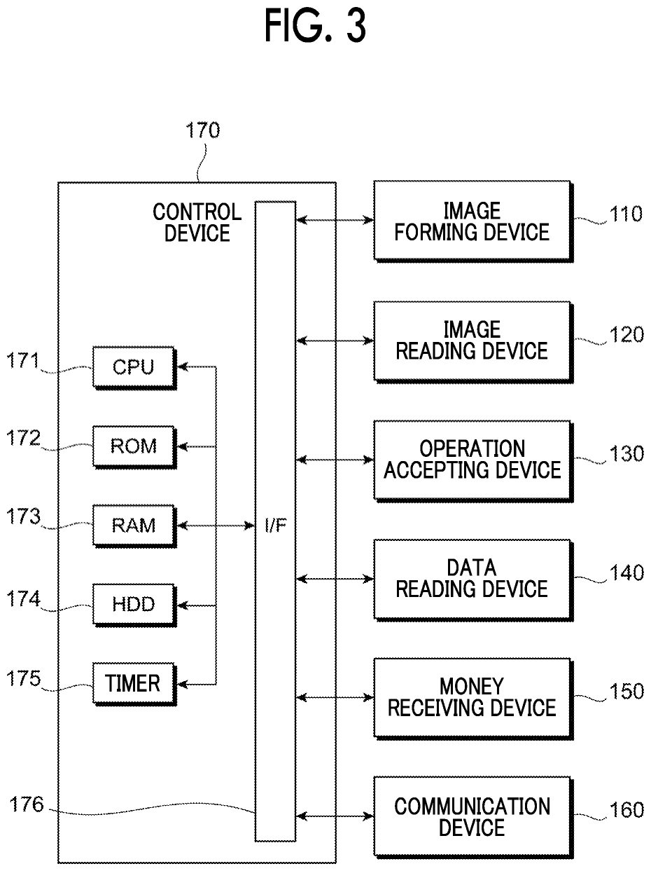

FIG. 3 is a diagram illustrating an example of a hardware configuration of the control device 170 provided in the image processing apparatus 100.

The control device 170 includes a central processing unit (CPU) 171 that reads and executes a program, a read only memory (ROM) 172 that stores a program to be executed by a CPU171, data used when executing the program, and the like, a random access memory (RAM) 173 that stores data temporarily generated when executing the program and the like, a hard disk drive (HDD) 174 that stores relatively large-capacity data such as image data and the like, and a timer 175 that measures time. The control device 170 includes an interface circuit (described as “I/F” in the drawing) 176 for connecting these CPU 171 to the timer 175, and the image forming apparatus 110, the image reading device 120, the operation accepting device 130, the data reading device 140, the money receiving device 150, and communication device 160.

### <Functional Configuration of Control Device>

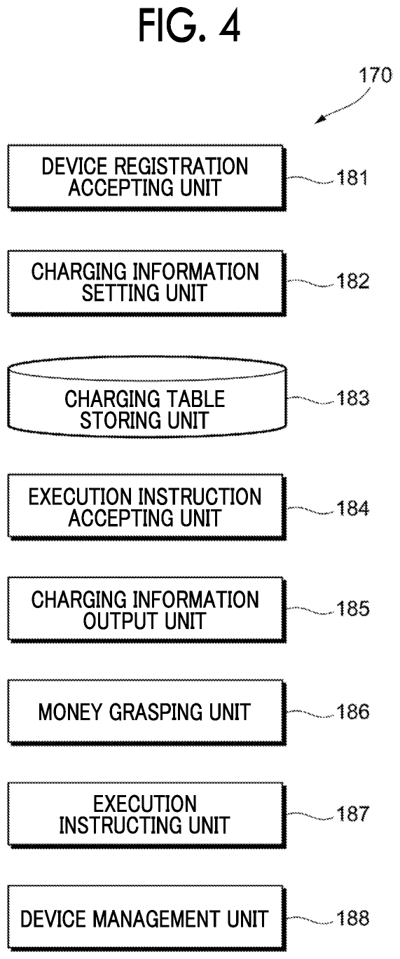

FIG. 4 is a block diagram illustrating an example of a functional configuration of the control device 170 provided in the image processing apparatus 100. The control device 170 includes a device registration accepting unit 181, a charging information setting unit 182, a charging table storing unit 183, an execution instruction accepting unit 184, a charging information output unit 185, a money grasping unit 186, an execution instructing unit 187, and a device management unit 188.

The device registration accepting unit 181 accepts registration of the electric device 200 that is a target of charging.

Specifically, for example, the device registration accepting unit 181 searches for the electric device 200 within a predetermined range by wired communication or wireless communication. The predetermined range is, for example, the range of the same network defined by the Internet protocol (IP) addresses, the range in which radio waves of wireless communication reach, or the like. The electric devices 200 found by the search are displayed on the screen of the operation accepting device 130, for example. Then, an administrator or the like of the information processing system 1 selects the electric device 200 to be registered as a target of charging among the electric devices 200 found by the search. By this selection, the device registration accepting unit 181 accepts registration of the electric device 200 which is a target of charging. In addition, the device registration accepting unit 181 acquires information such as a list of device types and functions from the electric device 200 registered as a target of charging.

Here, the device registration accepting unit 181 may register this electric device 200 as a target of charging after acquiring information such as a list of device types and functions from the electric device 200.

As for the list of functions of the electric device 200, for example, a list of standard functions may be prepared in advance for each device type, and the list of functions of this electric device 200 may be grasped based on the type of the electric device 200.

Further, the electric device 200 to be registered as a target of charging is not limited to the electric devices 200 found by the search. For example, when the administrator or the like of the information processing system 1 manually inputs the information of the electric device 200 to be registered as a target of charging, the device registration accepting unit 181 may accept the registration of the electric device 200 which is a target of charging.

In the present exemplary embodiment, the device registration accepting unit 181 is used as an example of an accepting unit.

The charging information setting unit 182 performs setting such that money for the electric device 200 registered as a target of charging can be received through the money receiving device 150.

Specifically, for example, the administrator or the like of the information processing system 1 inputs money information corresponding to the function of the electric device 200 for each electric device 200 registered as a target of charging. Then, the charging information setting unit 182 adds the input money information to the charging table. With this addition, setting is performed such that money for the electric device 200 can be received through the money receiving device 150.

In the present exemplary embodiment, the charging information setting unit 182 is used as an example of a setting unit.

The charging table storing unit 183 stores a charging table.

The information of the charging table may be shared with other image processing apparatuses 100. Details of the charging table will be described later.

The execution instruction accepting unit 184 accepts, from the user, an instruction for causing the electric device 200 to execute processing (hereinafter, referred to as “electric device execution instruction”). Specifically, for example, when the user operates the operation accepting device 130, the execution instruction accepting unit 184 accepts an electric device execution instruction.

In the following, the processing that the user is trying to make the electric device 200 execute according to the electric device execution instruction, and the processing corresponding to the electric device execution instruction is referred to as “instruction handling processing”.

The charging information output unit 185 refers to the charging table to output information on money to be charged to cause the electric device 200 to execute the instruction handling processing. The output information is displayed on the screen of the operation accepting device 130, for example.

In the present exemplary embodiment, the charging information output unit 185 is used as an example of an output unit.

The money grasping unit 186 grasps the amount of money received by the money receiving device 150 from the user. For example, the money grasping unit 186 detects that money has been put into the money receiving device 150 and grasps the amount of the put money.

The execution instructing unit 187 instructs the electric device 200 to execute instruction handling processing. Here, the execution instructing unit 187 instructs the electric device 200 to execute the instruction handling processing when the amount of money grasped by the money grasping unit 186 reaches the amount of money charged for executing the instruction handling processing.

In the present exemplary embodiment, the execution instructing unit 187 is used as an example of an instructing unit.

The device management unit 188 grasps whether or not the execution of the instruction handling processing in the electric device 200 has been normally completed. Here, when it is determined that the execution of the instruction handling processing in the electric device 200 is not completed normally, the device management unit 188 performs processing to refund the user. Details of the processing of refunding the user will be described later. On the other hand, when it is determined that the execution of the instruction handling processing in the electric device 200 is completed normally, the device management unit 188 displays, for example, a message indicating that the processing has been completed normally on the screen of the operation accepting device 130.

The following method is exemplified as a method of grasping whether or not the execution of the instruction handling processing is normally completed in the electric device 200.

For example, after the instruction handling processing is started in the electric device 200, the device management unit 188 periodically inquires of the electric device 200 about the execution status of the instruction handling processing, for example, every second.

In addition, for example, when the execution of the instruction handling processing is normally completed in the electric device 200, or when an error occurs during the execution of the instruction handling processing, the electric device 200 may notify the image processing apparatus 100 of the error. In this case, based on the notification from the electric device 200, the device management unit 188 grasps whether or not the execution of the instruction handling processing in the electric device 200 has been normally completed.

In the present exemplary embodiment, the device management unit 188 is used as an example of a grasping unit and a refund processing unit.

The respective functional units constituting the control device 170 are implemented by the cooperation of software and hardware resources. Specifically, for example, when the control device 170 is implemented by the hardware configuration illustrated in FIG. 3, various programs stored in the ROM 172, the HDD 174, or the like are read by the RAM 173 and executed by the CPU 171, thereby implementing functional units such as the device registration accepting unit 181, the charging information setting unit 182, the execution instruction accepting unit 184, the charging information output unit 185, the money grasping unit 186, the execution instructing unit 187, and the device management unit 188 illustrated in FIG. 4. The charging table storing unit 183 is implemented by, for example, a HDD 174.

### <Description of Charging Table>

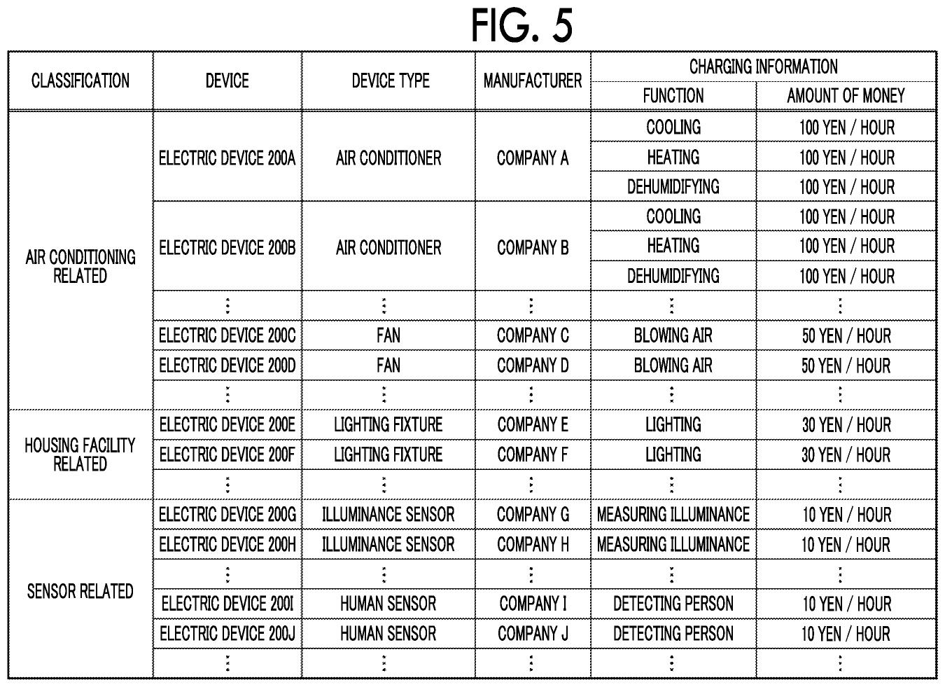

FIG. 5 is a diagram illustrating an example of a charging table.

In the illustrated example, electric devices 200A to 200J are illustrated as the electric devices 200 registered as the targets of charging. The electric devices 200A to 200D are air conditioning related devices, the electric devices 200E and 200F are housing facility related devices, and the electric devices 200G to 200J are sensor related devices. Information on money to be charged is set for each electric device 200.

For example, the electric devices 200A and 200B are air conditioners, and have functions of cooling, heating, and dehumidifying. When these functions are used, 100 Yen per hour is charged. The electric devices 200C and 200D are fans, and have a function of blowing air. When this function is used, 50 Yen per hour is charged. The electric devices 200E and 200F are lighting fixtures and, have a function of lighting. When this function is used, 30 Yen per hour is charged. The electric devices 200G and 200H are illuminance sensors, and are used to measure illuminance. When this function is used, 10 Yen per hour is charged. Further, the electric devices 200I and 200J are human sensors, and are used to detect a person. When this function is used, 10 Yen per hour is charged.

In this example, when the types of devices are the same, the amount of money charged is also the same. It is noted that the present disclosure is not limited to such a configuration. For example, the electric device 200A and the electric device 200B are air conditioners, and the device types are the same, but the amounts of money charged for these devices may be different from each other.

The electric devices 200A and 200B are air conditioners, but the manufacturer of the electric device 200A is Company A and the manufacturer of the electric device 200B is Company B. Likewise, electric devices 200 of different manufacturers are registered for fans, lighting fixtures, illuminance sensors, and human sensors. As described above, in the charging table, electric devices 200 of different manufacturers may be registered for the same type of electric device 200. By registering the electric devices 200 of different manufacturers, money for the electric devices 200 of different manufacturers can be received through the money receiving device 150.

### <Description of Processing of Refunding User>

Next, processing of refunding the user when execution of processing is not normally completed in the electric device 200 will be described.

After the execution instructing unit 187 instructs the electric device 200 to execute instruction handling processing, the device management unit 188 grasps whether or not the execution of the instruction handling processing in the electric device 200 is normally completed. When the execution of the instruction handling processing is not normally completed in the electric device 200, the device management unit 188 performs processing to refund the user.

Here, the device management unit 188 grasps the amount of money that the user has put to the money receiving device 150 in order to cause the electric device 200 to execute the instruction handling processing. Then, the device management unit 188 controls the money receiving device 150 to return the money put from the user. By this control, the money receiving device 150 returns money put by the user. The user may receive the returned money from the money receiving device 150.

In addition, the device management unit 188 may change the amount of money to be refunded in accordance with the execution status of the instruction handling processing by the electric device 200. For example, it is assumed that the user puts 100 Yen when the usage fee of the electric device 200 is 100 Yen for one hour, but the processing is interrupted when the electric device 200 has executed the instruction handling processing for 30 minutes. In this case, the device management unit 188 controls the money receiving device 150 to return the remaining 50 Yen by subtracting 50 Yen corresponding to 30 minutes for which the instruction handling processing is executed from the 100 Yen put by the user.

Further, when the money receiving device 150 returns money, if the user who has put money is not in the vicinity of the money receiving device 150, another user may receive the returned money. Therefore, when a user who has put money to the money receiving device 150 is within a predetermined range from the money receiving device 150, the device management unit 188 may refund the user. In other words, when a user who operates the image processing apparatus 100 and issues an electric device execution instruction is within a predetermined range from the image processing apparatus 100, the device management unit 188 may make the money receiving device 150 of the image processing apparatus 100 refund the user.

When there is no user who has put money to the money receiving device 150 within a predetermined range (that is, a predetermined range from the image processing apparatus 100) from the money receiving device 150, the device management unit 188 may notify a preset notification destination of information necessary for refund. Here, the preset notification destination is, for example, an e-mail address of a user who has put money to the money receiving device 150, and is preset by the user. The information necessary for refund is, for example, a refund code (for example, a security code) required to be input at the time of the refund. When the user inputs the refund code to the image processing apparatus 100 or the other image processing apparatus 100 to instruct the image processing apparatus 100 or the other image processing apparatus 100 to refund the user, a refund is made in the image processing apparatus 100 (or the other image processing apparatus 100) to which the refund code has been input.

In addition, when the money receiving device 150 returns money, there may be a case where a user who has put money is in the vicinity of another image processing apparatus 100. Therefore, when a user who has put money to the money receiving device 150 of the image processing apparatus 100 (that is, the user who has issued an electric device execution instruction) is within a predetermined range from another image processing apparatus 100, the device management unit 188 may make the money receiving device 150 of the other image processing apparatus 100 refund the user. In this case, when a user who has put money to the money receiving device 150 of the image processing apparatus 100 is within a predetermined range from the other image processing apparatus 100, the device management unit 188 instructs the other image processing apparatus 100 to refund the user. This instruction is performed, for example, when it is determined that an abnormality has occurred in the electric device 200 and that the user is to be refunded. However, the timing of issuing an instruction is not limited.

Further, in the above-described example, when there is no user who has put money into the money receiving device 150 within a predetermined range from the money receiving device 150, the device management unit 188 notifies information necessary for refund, but further, when the user is not within a predetermined range from the money receiving device 150 (that is, a predetermined range from the image processing apparatus 100) and a predetermined range from another image processing apparatus 100, the device management unit 188 may notify a preset notification destination of information necessary for refund. Also in this case, for example, when the user inputs the notified refund code to the image processing apparatus 100 or the other image processing apparatus 100 to instruct the image processing apparatus 100 or the other image processing apparatus 100 to refund the user, a refund is made in the image processing apparatus 100 (or the other image processing apparatus 100) to which the refund code has been input.

What kind of user is within a predetermined range from the money receiving device 150 (or the image processing apparatus 100) is determined by using, for example, a camera, a human sensor, or the like.

Further, based on the information input by a user, it may be determined whether or not the user to be refunded is within a predetermined range from the money receiving device 150 or the image processing apparatus 100. For example, when a user puts money, identification information (for example, a user ID) for identifying the user may be input, and at the time of refund, the identification information may be input again to determine whether the user is a user to be refunded. Further, for example, when a user puts money, identification information may be acquired by an ID card presented by the user, and at the time of refund, the user may be prompted to present the ID card again to determine whether the user is a user to be refunded.

<Procedure for Registering Electric Device which is Target of Charging>

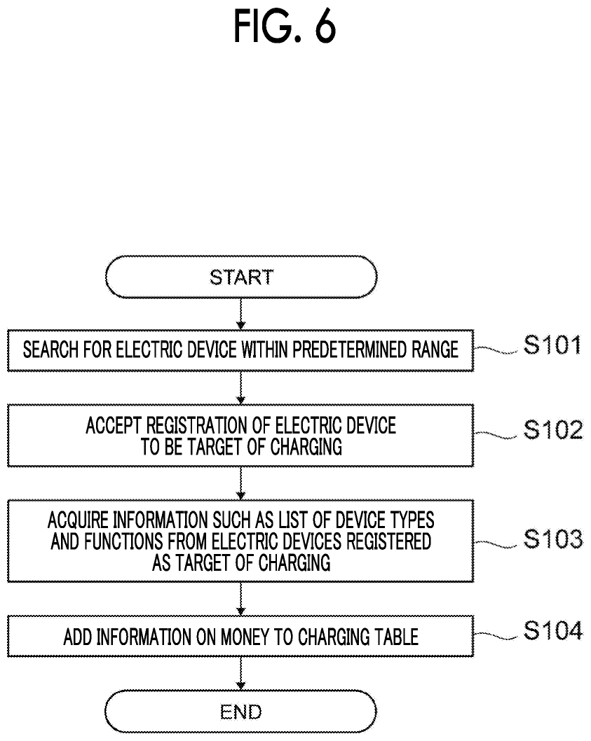

FIG. 6 is a flowchart illustrating an example of a procedure of processing of registering the electric device 200 which is a target of charging.

In the following, the steps of the processing are denoted by the symbol “S”.

For example, when the administrator or the like of the information processing system 1 instructs the operation accepting device 130 to search for the electric device 200, the device registration accepting unit 181 searches for the electric device 200 within a predetermined range (S101). The search result is displayed on the operation accepting device 130.

Next, when the administrator or the like of the information processing system 1 selects the electric device 200 from the electric devices 200 found by the search, the device registration accepting unit 181 accepts registration of the electric device 200 which is a target of charging (S102). Then, the selected electric device 200 is registered as a target of charging.

Next, the device registration accepting unit 181 acquires information such as a list of device types and functions from the electric devices 200 registered as targets of charging (S103).

Next, when the administrator or the like of the information processing system 1 inputs the information on the money of the electric device 200 registered as a target of charging, the charging information setting unit 182 adds the information on the put money to the charging table (S104). Here, when the information of the charging table is shared with another image processing apparatus 100, the content of the added information is transmitted to the other image processing apparatus 100. Then, the processing flow ends.

<Procedure for Receiving Money from User and Operating Electric Device>

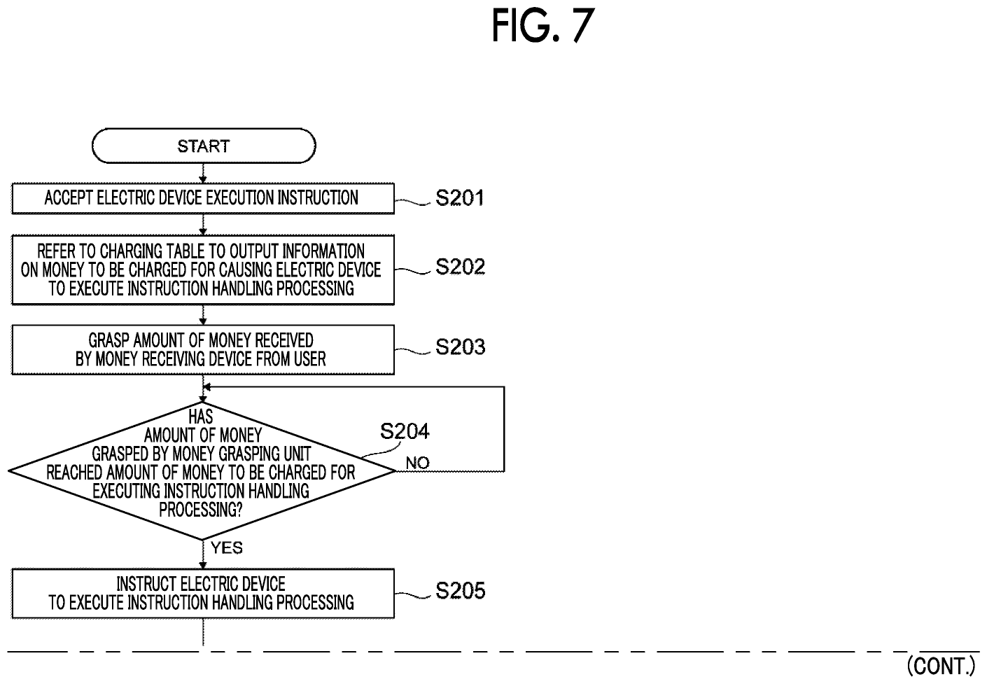

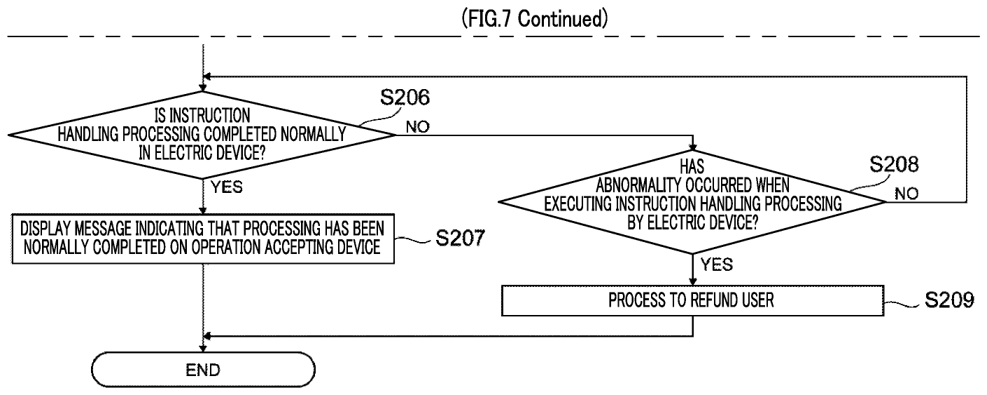

FIG. 7 is a flowchart illustrating an example of a procedure of processing of receiving money from the user and operating the electric device 200.

In the following, the steps of the processing are denoted by the symbol “S”.

For example, when the user operates the operation accepting device 130, the execution instruction accepting unit 184 accepts an electric device execution instruction (S201). Next, the charging information output unit 185 refers to the charging table to output information on money to be charged for causing the electric device 200 to execute instruction handling processing (S202). Next, when the user puts money into the money receiving device 150, the money grasping unit 186 grasps the amount of money received by the money receiving device 150 from the user (S203).

Next, the execution instructing unit 187 determines whether or not the amount of money grasped by the money grasping unit 186 has reached the amount of money to be charged for executing the instruction handling processing (S204). When a negative determination (NO) is made in S204, the processing of S204 is subsequently performed. On the other hand, when a positive determination (YES) is made in S204, the execution instructing unit 187 instructs the electric device 200 to execute instruction handling processing (S205).

Next, the device management unit 188 determines whether or not the instruction handling processing is normally completed in the electric device 200 (S206).

When a positive determination is made in S206 (YES), the device management unit 188 displays a message indicating that the processing has been normally completed on the operation accepting device 130 (S207). Then, the processing flow ends.

When a negative determination (NO) is made in S206, the device management unit 188 determines whether or not an abnormality has occurred when executing the instruction handling processing by the electric device 200 (S208). When a negative determination (NO) is made in S208, the instruction handling processing is being executed, and the process shifts to S206. On the other hand, when a positive determination (YES) is made in S208, the device management unit 188 performs processing of refunding the user (S209). Then, the processing flow ends.

<Specific Example of Processing of Registering Electric Device which is Target of Charging>

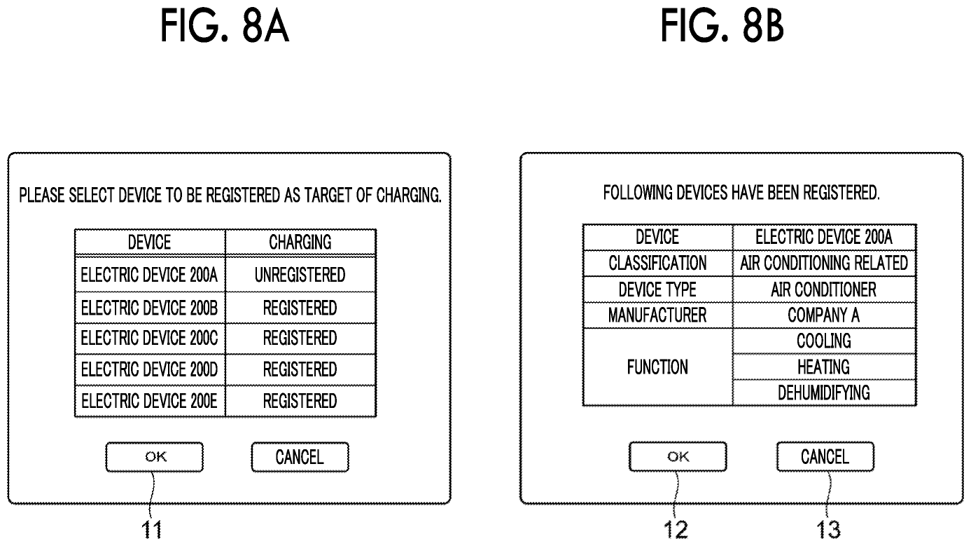

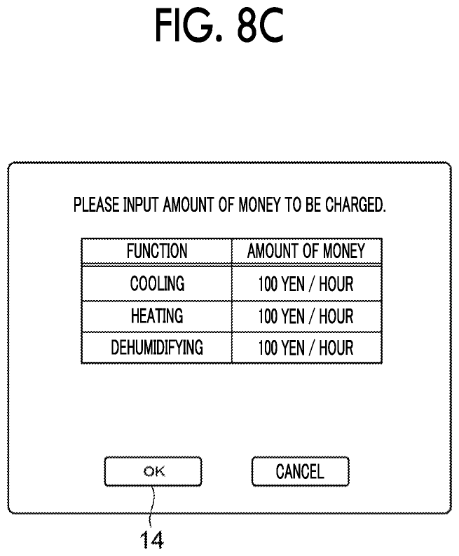

Next, processing of registering the electric device 200 which is a target of charging will be described with reference to a specific example. FIGS. 8A to 8C are diagrams illustrating a specific example of processing of registering the electric device 200 which is a target of charging. In this example, a case of registering the electric device 200A in the image processing apparatus 100A will be described.

The following steps correspond to the steps in FIG. 6.

For example, when the electric device 200A is newly installed, the administrator or the like of the information processing system 1 instructs the operation accepting device 130 of the image processing apparatus 100A to search for the electric device 200. In response to this instruction, the device registration accepting unit 181 of the electric device 200A searches for the electric device 200 connected to the same network as the network of the image processing apparatus 100A (S101). As a result, as illustrated in FIG. 8A, the electric device 200 found by the search is displayed on the operation accepting device 130.

In the example illustrated in FIG. 8A, the electric devices 200A to 200E are found. Among these devices, the electric devices 200B to 200E have already been registered as a target of charging, and the electric device 200A has not yet been registered. Here, when the administrator or the like selects the electric device 200A as a target of charging and presses an OK button 11, the electric device 200A is registered as a target of charging (S102). Then, the device registration accepting unit 181 acquires information such as a list of device type and functions from the electric device 200A (S103). As a result, as illustrated in FIG. 8B, the information acquired from the electric device 200A is displayed on the operation accepting device 130.

In the example illustrated in FIG. 8B, a list of classification, device type, manufacturer, and functions of the electric device 200A is illustrated. Specifically, the screen indicates that the electric device 200A is classified into air conditioning related and that an air conditioner is manufactured by Company A. The list also indicates that the electric device has functions of cooling, heating, and dehumidifying. When the administrator or the like presses an OK button 12, a screen illustrated in FIG. 8C is displayed next. When the administrator or the like presses a cancel button 13, the registration of the electric device 200A is canceled.

The screen illustrated in FIG. 8C is a screen for accepting money information of the electric device 200A. On this screen, an amount of money to be charged for each function of the electric device 200A can be input. In the example illustrated in FIG. 8C, the administrator or the like inputs 100 Yen as a usage fee per hour for each of the functions of cooling, heating, and dehumidifying. When the administrator or the like presses an OK button 14, the charging information setting unit 182 adds the input money information to the charging table (S104).

In this manner, the electric device 200A which is a target of charging is registered, and setting is performed such that money for the electric device 200A can be received through the money receiving device 150.

<Specific Example of Processing of Receiving Money from User and Operating Electric Device>

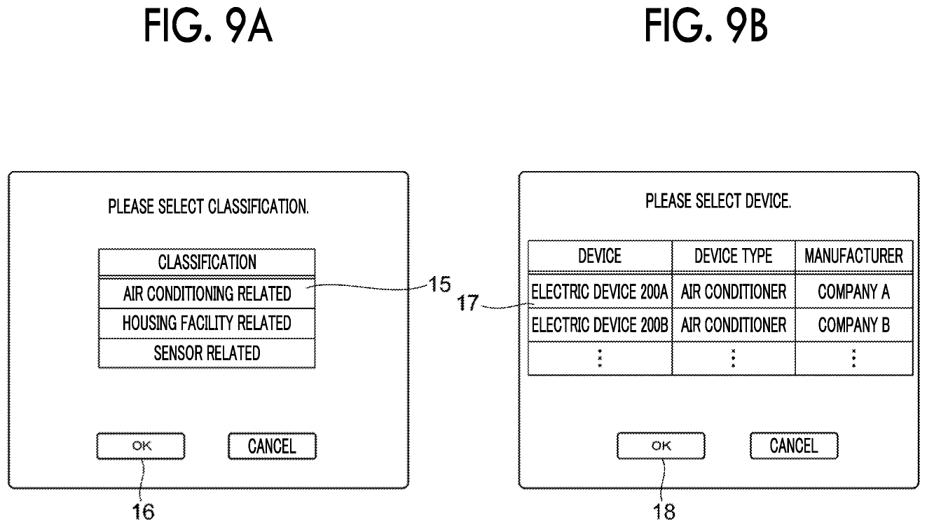

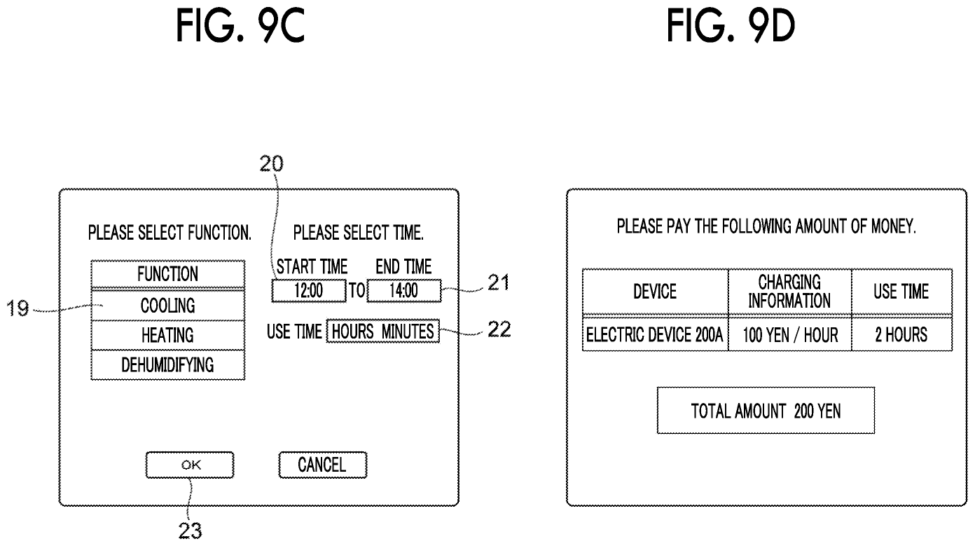

Next, processing of receiving money from the user and operating the electric device 200 will be described with reference to a specific example. FIG. 9 is a diagram illustrating a specific example of processing of receiving money from the user and operating the electric device 200. In this example, the charging table illustrated in FIG. 5 is used. In addition, a case where the user operates the electric device 200A in the image processing apparatus 100A will be described.

The following steps correspond to the steps in FIG. 7.

For example, as illustrated in FIG. 9A, a screen for accepting selection of classification of the electric device 200 is displayed on the operation accepting device 130 of the image processing apparatus 100A. In this example, the user operates the electric device 200A, which is an air conditioning-related air conditioner. Therefore, when the user selects an item 15 of “air conditioning related” and presses an OK button 16, a screen for accepting the selection of the device is displayed as illustrated in FIG. 9B. Here, when the user selects an item 17 of the electric device 200A and presses an OK button 18, a screen illustrated in FIG. 9C is displayed next.

The screen illustrated in FIG. 9C is a screen for receiving selection of a function and specification of time. In this example, the user uses a function of cooling from 12:00 for 2 hours. Therefore, the user selects an item 19 of “cooling” and inputs “12:00” in an input field 20 of start time and “14:00” in an input field 21 of end time. “12:00” may be input in the input field 20 of start time, and “2 hours 0 minutes” may be input in an input field 22 of use time. When the user presses an OK button 23, the execution instruction accepting unit 184 of the image processing apparatus 100A accepts an electric device execution instruction (S201). In addition, in this example, instruction handling processing is processing of executing the function of cooling for 2 hours.

Next, the charging information output unit 185 refers to the charging table illustrated in FIG. 5 to calculate the amount of money to be charged in order to execute the function of cooling in the electric device 200A for 2 hours. In the charging table illustrated in FIG. 5, since 100 Yen per hour is charged for the function of cooling of the electric device 200A, 200 Yen is charged in 2 hours. Therefore, as illustrated in FIG. 9D, the charging information output unit 185 outputs the fact that the amount of money is 200 Yen as charging information (S202).

Here, when the user puts 200 Yen into the money receiving device 150, the money grasping unit 186 grasps that the amount of money received from the user is 200 Yen (S203). Then, the execution instructing unit 187 instructs the electric device 200A to execute the function of cooling for 2 hours from 12:00 (YES in S204, S205). Here, for example, the execution instructing unit 187 may instruct the electric device 200A at the time when the user puts 200 Yen, or may instruct the electric device 200A at 12:00.

Next, the device management unit 188 determines whether or not the function of cooling is normally executed for 2 hours in the electric device 200A (S206). When the function is executed normally (YES in S206), a message to that effect is displayed on operation accepting device 130 (S207). On the other hand, when the function is not normally executed (NO in S206), the device management unit 188 performs processing to refund the user (S209). For example, the function is executed normally 1 hour from 12:00 to 13:00, but if an error occurred at 13:00 and the function is interrupted, the remaining one-hour fee (100 Yen in this example) will be refunded.

In this manner, the money receiving device 150 receives money from the user, and the electric device 200A executes the function of cooling. In addition, refund processing is performed as necessary.

In this example, before the electric device 200 executes the instruction handling processing, the electric device 200 receives money from the user. However, the present exemplary embodiment is not limited to such a configuration.

For example, it is also possible to receive money from the user after the execution of the instruction handling processing of the electric device 200 is normally completed. In this case, when the execution instruction accepting unit 184 receives an electric device execution instruction from the user, the execution instructing unit 187 instructs the electric device 200 to execute the instruction handling processing without money being put. Then, when the execution of the instruction handling processing is normally completed in the electric device 200, the information on money necessary for the instruction handling processing is output. The user may confirm the information on the money and put the money to the money receiving device 150. When the execution of the instruction handling processing is not normally completed, for example, the user may put only an amount of money corresponding to the execution of the instruction handling processing performed by the electric device 200.

<Another Example of Processing of Receiving Money from User and Operating Electric Device>

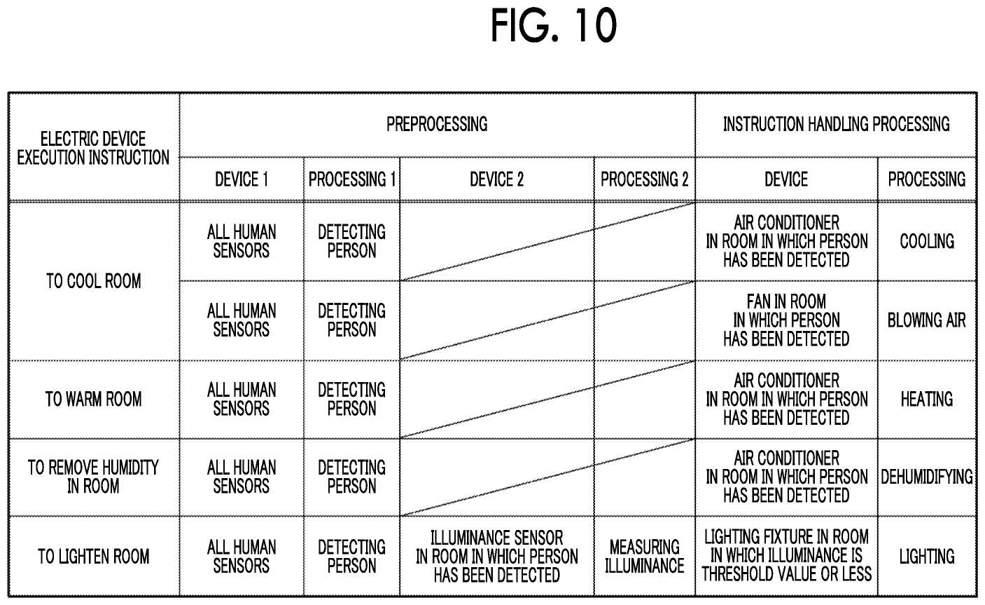

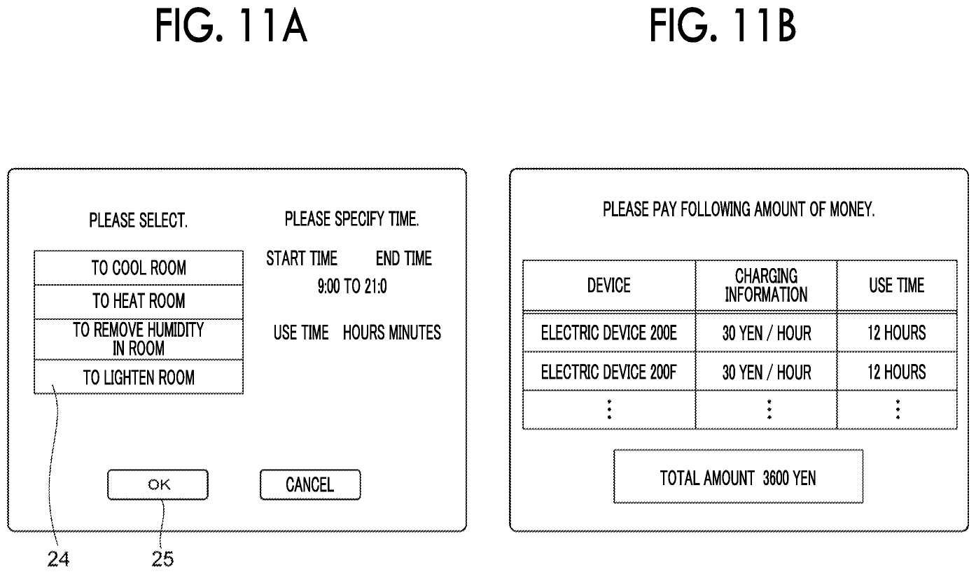

Next, another example of the processing of receiving money from a user and operating the electric device 200 will be described. FIGS. 10 and 11 are diagrams illustrating another example of the processing of receiving money from a user and operating the electric device 200.

In the example illustrated in FIG. 9, the user specifies the electric device 200 for executing instruction handling processing, but in the example illustrated in FIGS. 10 and 11, the image processing apparatus 100 determines the electric device 200 for executing the instruction handling processing.

First, as illustrated in FIG. 10, the administrator or the like of the information processing system 1 associates an electric device execution instruction with instruction handling processing in advance. In the example illustrated in FIG. 10, four instructions “to cool the room”, “to warm the room”, “to remove humidity in the room”, and “to lighten the room” are registered as electric device execute instructions. Further, the instruction handling processing is associated with each of the electric device execute instructions.

For example, in the case of “to cool the room”, first, it is registered that processing of detecting a person is executed for all human sensors as preprocessing. Next, as instruction handling processing, it is registered that a function of cooling is executed for an air conditioner in a room in which a person has been detected based on the result of executing processing of detecting a person. In addition, as instruction handling processing, it is also registered that a function of blowing air is executed for a fan in a room in which a person has been detected based on the result of executing processing of detecting a person.

Further, for example, in the case of “to lighten the room”, first, it is registered that the processing of detecting a person is executed for all the human sensors as preprocessing. In addition, as the next preprocessing, based on the result of executing processing of detecting a person, it is registered that processing of measuring the illuminance is executed for an illuminance sensor in a room in which a person has been detected. Next, as instruction handling processing, based on the result of executing processing of measuring the illuminance, it is registered that a function of lighting is executed for a lighting fixture in a room in which the illuminance is a threshold value or less.

When the user actually issues an electric device execute instruction, a list of electric device execution instructions is displayed as illustrated in FIG. 11A. This list is displayed, for example, on the operation accepting device 130 of the image processing apparatus 100. In this example, it is assumed that the user selects an item 24 of “to lighten the room”. The start time is 9:00, and the end time is 21:00.

Then, when the user presses an OK button 25, the execution instruction accepting unit 184 accepts an electric device execution instruction of “to lighten the room”. Next, the execution instructing unit 187 specifies processing corresponding to the electric device execution instruction with reference to the association illustrated in FIG. 10.

In this example, first, the execution instructing unit 187 instructs all of the electric devices 200 functioning as a human sensor to execute the processing of detecting a person. Next, the execution instructing unit 187 instructs the electric device 200 as an illuminance sensor in a room in which a person has been detected to execute the processing of measuring the illuminance based on the result of executing the processing of detecting a person. Next, the charging information output unit 185 specifies a lighting fixture in a room in which the measured illuminance is a threshold value or less, based on the result of executing the processing of measuring the illuminance. Then, the charging information output unit 185 refers to the charging table to calculate the amount of money to be charged in order to cause the specified lighting fixture to execute a function of lighting from 9:00 to 21:00, that is, 12 hours.

For example, when the number of specified lighting fixtures is 10 and the usage fee per hour of each lighting fixture is 30 Yen, the amount of money to be charged is 10 units×30 Yen/hour×12 hours=3600 Yen. Then, as illustrated in FIG. 11B, a message indicating that the amount of money is 3600 Yen is output as charging information. Here, when the user puts 3600 Yen into the money receiving device 150, the execution instructing unit 187 instructs the 10 lighting fixtures to execute a function of lighting between 9:00 and 21:00.

In this example, when the human sensor is an example of a specific type of device, the illuminance sensor is an example of another type of device. In the case where the illuminance sensor is an example of a specific type of device, the lighting fixture is an example of another type of device.

Further, in this example, although the electric device 200 to be used is fixed, the electric device 200 to be used may be changed depending on the situation. Specifically, for example, the lighting fixture to be lighted may be changed in accordance with the movement of a person. In this case, since the presence or absence of lighting of the lighting fixture is determined in accordance with the movement of a person, the amount of money to be charged is not determined when the user issues an electric device execution instruction. After all the processing of the electric device 200 is completed, the amount of money to be charged is determined.

For example, on the screen illustrated in FIGS. 11A and 11B, the user selects an item 24 of “to lighten the room” and sets the start time to 9:00 and the end time to 21:00. Here, when the user presses an OK button 25, the execution instructing unit 187 specifies processing corresponding to the electric device execution instruction with reference to the association illustrated in FIG. 10.

In this example, as the processing corresponding to “to lighten the room”, the processing of detecting a person for all human sensors, the processing of measuring the illuminance for the illuminance sensor in a room in which a person has been detected, and the processing of lighting for the lighting fixture in a room in which the illuminance is the threshold value or less are specified. When a series of these processing are performed periodically, for example, every second, the lighting fixtures of a room in which a person is located are lighted, and the lighting fixtures of a room in which a person is not located are lighted out in accordance with the movement of the person. Between 9:00 and 21:00, after a series of these processing are performed, the amount of money to be charged is determined.

For example, all of the human sensors perform processing of periodically detecting a person for 12 hours from 9:00 to 21:00. When the usage fee per hour of a certain human sensor is 10 Yen, the usage fee of this human sensor is 120 Yen.

Further, for example, for the illuminance sensor, the total time obtained by measuring the illuminance between 9:00 and 21:00 is calculated based on the log of the illuminance sensor. For example, when the total time for which illuminance is measured by a certain illuminance sensor is 6 hours and the usage fee per hour is 10 Yen, the usage fee of this illuminance sensor is 60 Yen.

Further, for example, for the lighting fixture, the total time of lighting between 9:00 and 21:00 is calculated based on the log of the lighting fixture. For example, when the total time for which a certain lighting fixture lighted is 6 hours and the usage fee per hour is 30 Yen, the usage fee of this lighting fixture is 180 Yen.

The total amount of the sum of all the amounts of the electric devices 200 is the amount of money to be charged to the user.

(Processing when there are Plural Electric Devices that Can Execute Instruction Handling Processing)

When an electric device execution instruction is received from a user, there may be plural electric devices 200 capable of executing instruction handling processing corresponding to the electric device execution instruction. Specifically, for example, in the example illustrated in FIG. 10, there are an air conditioner and a fan as the electric devices 200 capable of executing the instruction handling processing corresponding to “to cool the room”. In this case, information on money to be charged may be output for each type of the electric device 200.

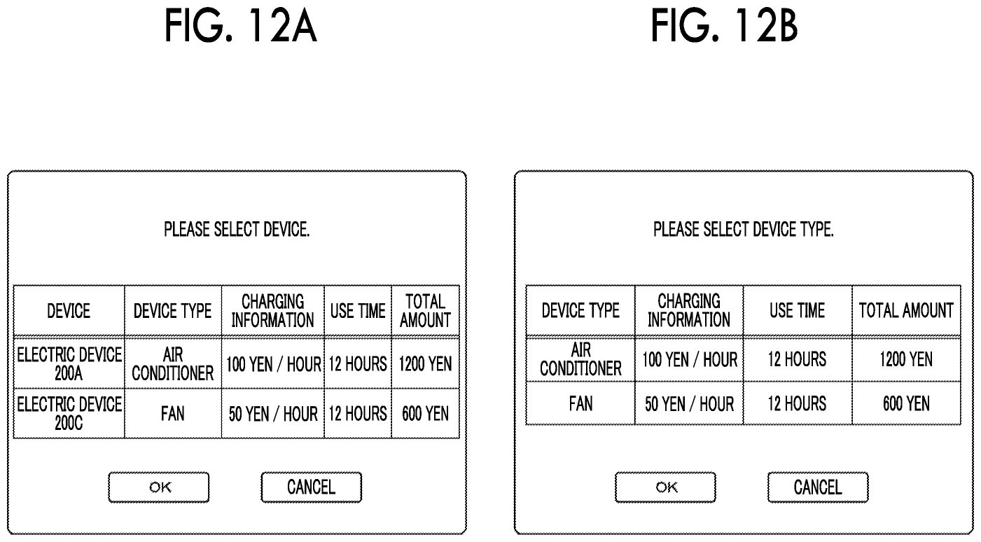

FIGS. 12A and 12B are diagrams illustrating an example of a case where information on money to be charged is output according to a type of electric device 200.

The example illustrated in FIG. 12A is an example in which the electric device 200 to be used is fixed. FIG. 12A illustrates that when the electric device 200A is used as an air conditioner, 100 Yen per hour is charged. FIG. 12A also illustrates that when the electric device 200C is used as a fan, 50 Yen per hour is charged. The user may check the amount of money of each of the electric devices 200 to select which of the electric devices 200A and 200C is to be used.

The example illustrated in FIG. 12B is an example in which the electric device 200 to be used is changed depending on the situation. In this example, the amounts of money to be charged per hour for the air conditioner and the fan are illustrated. For example, FIG. 12B illustrates that when an air conditioner is used, 100 Yen per hour is charged. FIG. 12B also illustrates that when a fan is used, 50 Yen per hour is charged. As these amounts of money, for example, the average amounts of all the air conditioners and the average amounts of all the fans are used. The user may check each amount of money and select whether to use an air conditioner or a fan.

Further, when there are plural electric devices 200 capable of executing the instruction handling processing, an instruction to execute the instruction handling processing may be issued to the electric device 200 for which the money to be charged satisfies a predetermined condition, regardless of the selection of the user. For example, as a predetermined condition, a condition that the money to be charged is the lowest is exemplified. In this case, in the example illustrated in FIG. 12A, the electric device 200C with a low amount of money to be charged is selected. Therefore, when the user puts 600 Yen into the money receiving device 150, the execution instructing unit 187 instructs the electric device 200B to execute a function of blowing air. Further, in the example illustrated in FIG. 12B, a fan with a low amount of money to be charged is selected. Therefore, the execution instructing unit 187 instructs the fan in a room in which a person has been detected to execute a function of blowing air.

<Processing when Communication Between Image Processing Apparatus and Electric Device has a Failure>

Next, processing in a case where there is a failure in communication between the image processing apparatus 100 and the electric device 200 will be described.

For example, when the user operates the operation accepting device 130 of the image processing apparatus 100A to cause the electric device 200A to execute the instruction handling processing, there may be a failure in the communication between the image processing apparatus 100A and the electric device 200A, and the image processing apparatus 100A may not be able to instruct the electric device 200A to execute the instruction handling processing. In this case, the execution instructing unit 187 of the image processing apparatus 100A instructs another image processing apparatus 100 (for example, the image processing apparatus 100B) that can communicate with the electric device 200A to execute the instruction handling processing in the electric device 200A.

For example, upon receiving an instruction from the image processing apparatus 100A, the image processing apparatus 100B instructs the electric device 200A to execute the instruction handling processing. In response to this instruction, the electric device 200A executes the instruction handling processing. In addition, the image processing apparatus 100B grasps whether or not the execution of the instruction handling processing is normally completed in the electric device 200A.

When the execution of the instruction handling processing is normally completed in the electric device 200A, the image processing apparatus 100B notifies the image processing apparatus 100A that the execution of the instruction handling processing of the electric device 200A is normally completed. Then, the image processing apparatus 100A displays, on the operation accepting device 130, a message or the like indicating that the execution of the instruction handling processing of the electric device 200A is normally completed. Here, the image processing apparatus 100B may display a message or the like indicating that the execution of the instruction handling processing of the electric device 200A is normally completed.

When the execution of the instruction handling processing is not normally completed in the electric device 200A, the image processing apparatus 100B notifies the image processing apparatus 100A that the execution of the instruction handling processing of the electric device 200A is not normally completed. Then, the image processing apparatus 100A performs processing to refund the user. Here, the image processing apparatus 100B may process to refund the user.

### <Other Configuration Examples>

In the present exemplary embodiment, when the user uses a credit card, the money receiving device 150 may exchange with a server device or the like of a credit card company to complete payment by the user. In this case, the user pays money to the credit card company. When the execution of the instruction handling processing is not normally completed and refund processing is performed, for example, after the payment is made once with a credit card, processing of canceling the payment is performed. In addition, for example, only the amount of money corresponding to the execution of the instruction handling processing by the electric device 200 may be paid by a credit card.

In the present exemplary embodiment, some of the functions of the image processing apparatus 100 may be performed by another apparatus. For example, the image processing apparatus 100 may accept an electric device execution instruction from a portable terminal (not illustrated) by the user operating the portable terminal instead of the operation accepting device 130. For example, a server device (not illustrated) may be provided to collect data detected by the electric device 200. The server device collects data detected by, for example, an illuminance sensor, a human sensor, or the like, and transmits the collected data to the image processing apparatus 100.

### <Other Examples of Hardware Configurations>

Although the configuration using the image processing apparatus 100 has been described in the present exemplary embodiment, the present exemplary embodiment may be implemented by another apparatus having a unit that receives money from a user. Therefore, the hardware configuration of a computer 400 will be described assuming that the computer 400 such as a personal computer (PC) is used instead of the image processing apparatus 100. The computer 400 is used as an example of an information processing apparatus.

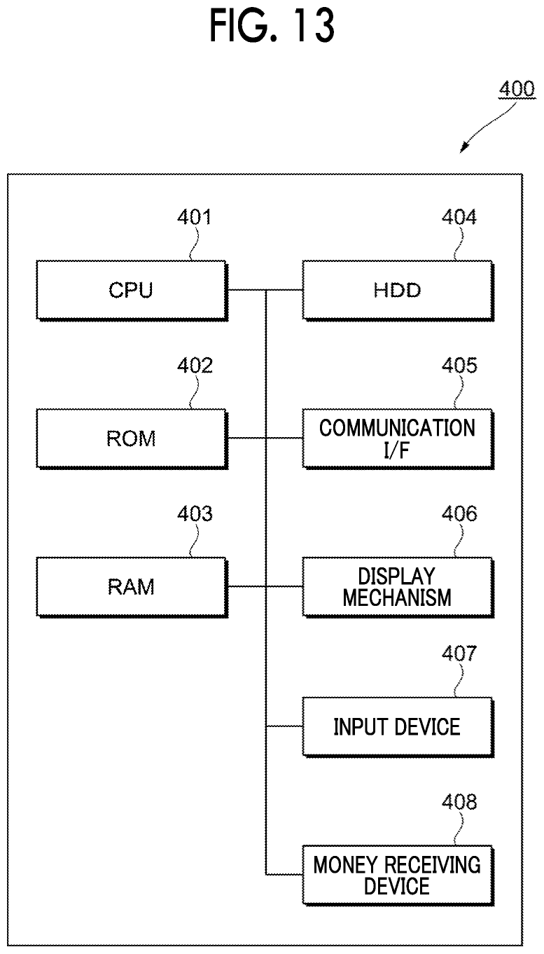

FIG. 13 is a diagram illustrating an example of a hardware configuration of the computer 400 to which the present exemplary embodiment is applied.

As illustrated in the drawing, the computer 400 includes a CPU 401 which is a computing unit, a ROM 402 which is a storage area for storing a program such as basic input output system (BIOS), and a RAM 403 which is an area for executing the program. In addition, the computer 400 includes a HDD 404 which is a storage area for storing various programs such as an operating system (OS) and applications, input data to the various programs, output data from the various programs, and the like. Programs stored in the ROM 402, the HDD 404, or the like are read into the RAM 403 and executed by the CPU 401, thereby implementing the functions of the computer 400.

The computer 400 further includes a communication interface (I/F) 405 for communicating with the outside, a display mechanism 406 such as a display, and an input device 407 such as a keyboard, a mouse, and a touch panel.

The computer 400 includes a money receiving device 408 for receiving money from a user.

The program for implementing the exemplary embodiment of the present disclosure can be provided not only by a communication unit but also in a state of being stored in a computer-readable recording medium such as a semiconductor memory.

Although various exemplary embodiments and modification examples have been described above, these exemplary embodiments and modification examples may of course be combined.

In addition, the present disclosure is not limited to the above-described exemplary embodiments in any way, and can be implemented in various forms without departing from the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a money receiving device that is used for receiving money for the information processing apparatus from a user;
an accepting unit configured to accept registration of a device other than the information processing apparatus, the device being a target of charging; and
a setting unit configured to perform setting such that money for the registered device can be received through the money receiving device.

2. The information processing apparatus according to claim 1, further comprising:
an instructing unit configured to, when processing is performed in the registered device, instruct the device to execute the processing after the money receiving device receives money for the processing; and
a grasping unit configured to grasp whether or not the execution of the processing is normally completed in the device.

3. The information processing apparatus according to claim 2, wherein
when there is a failure in communication with the device, the instructing unit instructs another information processing apparatus capable of communicating with the device to execute the processing in the device.

4. The information processing apparatus according to claim 2, further comprising:
a refund processing unit configured to, when the execution of the processing is not normally completed in the device, perform processing to refund the user.

5. The information processing apparatus according to claim 4, wherein
when there is a user who instructs to execute the processing in a predetermined range from the information processing apparatus, the refund processing unit refunds the user.

6. The information processing apparatus according to claim 4, wherein
when there is no user who instructs to execute the processing in a predetermined range from the information processing apparatus, the refund processing unit notifies a preset notification destination of information necessary for refund.

7. The information processing apparatus according to claim 4, wherein
when there is a user who instructs another information processing apparatus to execute the processing in a predetermined range from the other information processing apparatus, the refund processing unit instructs to refund the user.

8. The information processing apparatus according to claim 7, wherein
when there is no user who instructs to execute the processing in the predetermined range from the information processing apparatus and the predetermined range from the other information processing apparatus, the refund processing unit notifies a preset notification destination of information necessary for refund.

9. The information processing apparatus according to claim 1, further comprising:
an output unit configured to, when the registered device is caused to execute processing corresponding to an instruction from the user, output information on money to be charged for the processing and to be received by the money receiving device from the user.

10. The information processing apparatus according to claim 9, wherein
when, among the registered devices, there are a plurality of types of devices that are capable of executing the processing corresponding to the instruction from the user, the output unit outputs the information on money to be charged for the processing for each type.

11. The information processing apparatus according to claim 1, wherein
the registered device comprises a plurality of registered devices, the information processing apparatus further comprising:
an instructing unit configured to, when, among the registered devices, there are a plurality of devices that are capable of executing processing corresponding to an instruction from the user, instruct a device for which money to be charged for the processing satisfies a predetermined condition to execute the processing from among the plurality of devices.

12. The information processing apparatus according to claim 1, further comprising:
an instructing unit configured to, when the registered device is caused to execute processing corresponding to an instruction from the user, instruct a specific type of device to execute specific processing and then instruct another type of device to execute another processing based on a result of executing the specific processing.

13. A non-transitory computer readable medium storing a program that causes a computer comprising a money receiving device that is used for receiving money for an information processing apparatus from a user, to execute information processing, the information processing comprising:
accepting registration of a device other than the information processing apparatus, the device being a target of charging; and
performing setting such that money for the registered device can be received through the money receiving device.

14. An information processing apparatus comprising:
money receiving means that is used for receiving money for the information processing apparatus from a user;
accepting means for accepting registration of a device other than the information processing apparatus, the device being a target of charging; and
setting means for performing setting such that money for the registered device can be received through the money receiving means.
